(19) United States
(12) Patent Application Publication
(10) Pub. No.: US 2012/0264018 A1
(43) Pub. Date: Oct. 18, 2012

(54) COMPOSITE POSITIVE ELECTRODE MATERIAL WITH CORE-SHELL STRUCTURE FOR LITHIUM ION BATTERIES AND PREPARING METHOD THEREOF

(76) Inventors: Lingyong Kong, Shenzhen (CN); Xuewen Ji, Shenzhen (CN); Yunshi Wang, Shenzhen (CN)

(21) Appl. No.: 13/514,606

(22) PCT Filed: Sep. 29, 2010
(86) PCT No.: PCT/CN10/77446

§ 371 Date: Jun. 8, 2012

(30) Foreign Application Priority Data
Dec. 16, 2009 (CN) 200910189027.9

(51) Int. Cl. H01M 4/485; H01M 4/583; B05D 5/12; H01M 4/505; H01M 4/525; B82Y 30/00

(52) U.S. Cl. 429/220; 429/221; 429/224; 429/222; 427/58; 977/742

(57) ABSTRACT

A composite positive electrode material with a core-shell structure for a lithium ion battery consists of a core active material and a shell active material. The core active material is a lithium iron phosphate or a lithium manganate, and the shell active material is a composite lithium iron phosphate with carbon. The carbon is one or more of carbon nanotube, superfine conductive carbon black and amorphous carbon material. The composite positive electrode material includes from 65% to 99% core active material and from 1% to 35% shell active material, based on the total weight of the composite positive electrode material. The composite positive electrode material has stable property and excellent electrochemistry performance. The lithium ion battery made with the material has higher charge-discharge capacity, excellent cycle performance. It can be charged quickly and discharged at high rate. A preparing method for the composite positive electrode material is also provided.

### FIELD OF THE INVENTION

The present invention relates to a positive electrode material of lithium-ion batteries and, more particularly, to a composite positive electrode material with a core-shell structure for lithium-ion batteries of nanometer level.

### BACKGROUND OF THE INVENTION

Green secondary battery is a kind of recycled and clean new energy efficient. Its application has comprehensive soothing effects on energy, resources and environment problems. Especially, the power supply systems of portable electronic products, electric vehicles, aerospace and defense equipment, all of which rapidly develop based on the green battery in recent years, and many applications of photovoltaic energy storage, energy storage load power station, and uninterrupted power supply and so on, all without exception show the basic support role of green battery for today's social sustainable development. As one of the most crucial parts of lithium-ion battery, the positive electrode materials used in commercial application mainly is lithium transition metal oxides, which includes lithium cobalt oxide (LiCoO₂), lithium nickel oxide (LiNiO₂), lithium mangante (LiMnO₂) and lithium cobalt-nickel-manganese oxide material (LiNi_{1-x-y}CoₓMn_{y}O₂ (0≦x, y≦1, x+y≦1), all of which has a stratiform structure, lithium mangante (LiMn₂O₄) with a spinel structure, lithium vanadium phosphate (Li₃V₂(PO₄)₃ with a NASCION structure and poly-anionic positive materials such as metallic lithium phosphate (LiMPO₄) and metallic lithium silicate (Li₂MSiO₄). All kinds of the positive materials have their respective outstanding advantages, but also have their own defects. A lithium-ion battery prepared by single positive electrode material cannot meet the requirements of different electricity appliances. Therefore, a composite positive electrode material becomes a research focus.

The lithium mangante, as a positive electrode material for batteries, has some advantages as follows: (1) moderate capacity, high average voltage and good safety; (2) low price, wide raw material sources and easy for synthesizing. Its main disadvantages are: poor cycle performance, special quick capacity attenuation especially when the temperature is higher than 55° C. because the structure of lithium mangante will be changed during the cyclic process. Lithium mangante can be classified into LiMnO₂ with a stratiform structure, Li₂MnO₃ with a stratiform structure and LiMn₂O₄ with a spinel structure. In Li₂MnO₃, all octagonal positions are occupied, lithium can not be embedded, at the same time, all manganese ions are oxidized to be +4, lithium ion is not easy to happen deintercalation, thus, as an electrode material for lithium-ion batteries, it does not have activity. LiMnO₂ has an a-NaFeO₂ type structure, its theoretical capacity reaches up to 286 mAh/g and it is stable in the air, so it is a very attractive positive electrode material. The problem is that its structure is instability after taking off lithium and will transform to be a spinel structure slowly. The repeated changes of the crystal structure will induce repeated expansions and contractions of its volume, and then lead to a bad cycle performance. LiMn₂O₄ has a spinel structure of Fd3m space group, not only can happen lithium intercalation and deintercalation, but also can change voltage, capacity and circulate performance by doping anion and cation and changing type and quantity of doped ion. The theoretical discharge capacity of LiMn₂O₄ is 148 mAh/g, and the actual discharge capacity is 110˜120 mAh/g.

Compared with the base materials Co, Ni and Mn, the greatest advantage of lithium iron phosphate LiFePO₄ is non-toxic, it also has good safety, wide raw materials source, higher capacity (theoretical capacity is 170 mAh/g, energy density is 550 Wh/Kg), good stability, etc, and it is a new generational positive material having most potential of developments and applications for lithium ion batteries. This material has a peridot structure, its anion has a closepacked hexagonal arrangement, its cation occupies a half of the octagonal gap and one in eight of the tetrahedron space, and it can intercalate and deintercalate lithium-ion reversibly. Because the electrochemical process of LiFePO₄ is diffusion control, ionic conductivity and electronic conductivity is small, its capacity is decreased fast when the high current discharging. The related study mainly focuses on improving conductivity and capacity density, etc.

Both of lithium iron phosphate and lithium mangante have some characteristics of non-toxic, non-polluting, good safety performance, wide raw material sources, etc, but they also have their own shortcomings. For combining the advantages of lithium iron phosphate and lithium mangante as much as possible and overcoming their respective shortcomings, a carbon-encapsulated core-shell structural material becomes one of the main hot topics.

### SUMMARY OF THE INVENTION

One objective of the present invention is to provide a composite positive electrode material with a core-shell structure for a lithium-ion battery, which has advantages of non-toxic, non-polluting, good safety, stable property and excellent electrochemistry performance. The lithium-ion battery made of the above-mentioned material has higher charge-discharge capacity, excellent cycle performance, it can be charged quickly and discharged at high rate, it is adaptable to ultra-low temperature working environment, and it is safe and stable.

Another objective of the present invention is to provide a preparing method of the composite positive electrode material.

To achieve one of above-mentioned objectives, the present invention provides a composite positive electrode material which has a core-shell structure. The core-shell structure is consists of a core active material and a shell active material. The core active material is a lithium iron phosphate or a lithium manganate, and the shell active material is a composite lithium iron phosphate with carbon. The carbon is one or more of carbon nanotube, superfine conductive carbon black and amorphous carbon material. The composite positive electrode material includes from 65% to 99% core active material and from 1% to 35% shell active material, based on the total weight of the composite positive electrode material.

Preferably, the shell active material includes from 1% to 10% carbon, based on the total weight of the shell active material.

Preferably, the lithium iron phosphate is Li_{1-X}M_{X}FePO₄ or LiFe_{1-y}M_{y}PO₄, the doped element M of which is selected from one or more of boron, cadmium, copper, magnesium, aluminum, zinc, titanium, zirconium, niobium, chromium and rare-earth element, the value ranges of variable x is 0<x<1 and the value ranges of variable y is 0<y<1.

Preferably, the doped element M is selected from at least one of boron and cadmium.

Preferably, the lithium manganate is LiMnO₂ which has a stratiform structure or LiMn₂O₄ which has a spinel structure.

To achieve the other objective, the present invention further provides a preparing method of the composite positive electrode material which includes the following steps:

(a) preparing a core active material which includes: dissolving stoichiometric lithium source, iron source, phosphorus source, doped element source or stoichiometric lithium source, manganese source into an aqueous solution which contains complexing agent, putting the solution in nitrogen and heating the solution at a temperature of 100˜200° C. for 1˜2 hours to get gels, sintering the gels in inert or reducing atmosphere at a temperature of 500˜900° C. and keeping the sintering temperature constant for 3˜16 hours to get a core active material.

(b) preparing a composite positive material which includes: dissolving stoichiometric lithium source, iron source, phosphorus source, doped element source into an aqueous solution which contains complexing agent, mixing a carbon and an accessory ingredient and then ultrasonic dispersing into an aqueous solution, mixing the two kinds of solutions and adding the core active material to form a mixed solution, heating the mixed solution at a temperature of 100˜200° C. for 1˜2 hours to get gels, sintering the gels in inert or reducing atmosphere at a temperature of 500˜900° C., and keeping the sintering temperature constant for 3˜16 hours to get a composite positive electrode material with a core-shell structure for lithium-ion batteries.

Preferably, in the step (a), the weight of complexing agent is 0.1˜10 times of the total weight of lithium source, iron source, phosphorus source and doped element source or the total weight of lithium source and manganese source.

Preferably, in the step (b), the weight ratio of carbon and accessory ingredient is 1:0.01˜10; the weight of complexing agent is 0.1˜10 times of the total weight of lithium source, iron source, phosphorus source and doped element source.

Preferably, the lithium source is one or more of lithium oxide, lithium hydroxide, lithium acetate, lithium carbonate, lithium nitrate, lithium nitrite, lithium phosphate, lithium dihydrogen phosphate, lithium oxalate, lithium chloride, lithium molybdate, lithium vanadate; the iron source is one or more of ferric phosphate, ferrous phosphate, ferrous pyrophosphate, ferrous carbonate, ferrous chloride, ferrous hydroxide, ferrous nitrate, ferrous oxalate, ferric chloride, ferric hydroxide, ferric nitrate, ferric citrate, ferric sesquioxide; the phosphorus source is one or more of phosphoric acid, diammonium phosphate, ammonium dihydrogen phosphate, ferric phosphate, lithium dihydrogen phosphate; the manganese source is one or more of manganese nitrate, manganese acetate, manganese chloride; the doped element source is a soluble-salt of doped element M; the complexing agent is one or more of citric acid, malic acid, tartaric acid, oxalic acid, salicylic acid, succinic acid, glycocoll, edetic acid, sucrose, glucose; the accessory ingredient is one or more of polyving akohol, polyethylene glycol, polyoxyethylene, sodium polystyrene sulfonate, triton S-100, polyoxyethylene nonyl phenyl ether, hexadecyl trimethyl ammonium chloride, hexadecyl trimethyl ammonium bromide, octadecyl trimethyl ammonium chloride, octadecyl trimethyl ammonium bromide.

Preferably, the inert or reductive atmosphere is one or more of hydrogen, nitrogen, argon, paraffin, alkene, alcohol and ketone.

The contributions of the present invention are: because of the use of core-shell structure, it can effectively improve the conductivity and circulation stability at high rate of the positive electrode active material and effectively improve the specific capacity and specific energy of the positive electrode active material in the condition of charging and discharging at high rate. The lithium-ion battery made of the above-mentioned material has higher charge-discharge capacity, excellent cycle performance, it can be charged quickly and discharged at high rate, it is adaptable to ultra-low temperature working environment, and it is safe and stable. It is an ideal material for manufacturing a lithium-ion battery.

### BRIEF DESCRIPTION OF THE DRAWINGS

FIG. 1 is a transmission electron micrograph showing nanoparticles of a core-shell structure of the lithium mangante or lithium iron phosphate according to the first embodiment of the present invention;

FIG. 2 is a high resolution transmission electron micrograph showing nanoparticles of a core-shell structure of the lithium mangante or lithium iron phosphate according to the second embodiment of the present invention.

### DETAILED DESCRIPTION OF ILLUSTRATED EMBODIMENTS

The following embodiments are provided for further explaining and illustrating the present invention but not for restricting the present invention.

### The First Embodiment

(a) Preparing a core active material which includes: dissolving 320 g glucose into 1000 g water; adding 69 g lithium nitrate (LiNO₃, 1 mol) and 251 g manganese nitrate (Mn(NO₃)₂.4H₂O, 1 mol) into the solution; putting the solution in nitrogen and heating the solution at a temperature of 100° C. for 2 hours to get gels; sintering the gels in hydrogen atmosphere and at a temperature of 500° C., and keeping the sintering temperature constant for 16 hours to get a core active material lithium manganate LiMnO₂.

(b) Preparing a composite positive material with a core-shell structure for a lithium-ion battery which includes: dissolving 586 g glucose into 1000 g water; adding 10.35 g lithium nitrate (LiNO₃, 0.15 mol), 80.8 g ferric nitrate (Fe(NO₃)₃.9H₂O, 0.2 mol), 23 g ammonium dihydrogen phosphate (NH₄H₂PO₄, 0.2 mol) and 3.1 g boric acid (H₃BO₃, 0.05 mol) into the solution; mixing 3 g carbon nanotube and 3 g polyving akohol and then ultrasonic dispersing into water; mixing two above-mentioned solutions together and adding the core active material lithium manganate LiMnO₂ obtained by implementing step (a) to form a mixed solution; heating the mixed solution at a temperature of 200° C. for one hour to get gels; sintering the gels in hydrogen atmosphere and at a temperature of 600° C., and keeping the sintering temperature constant for 12 hours to get a composite positive electrode material with a core-shell structure for lithium-ion batteries.

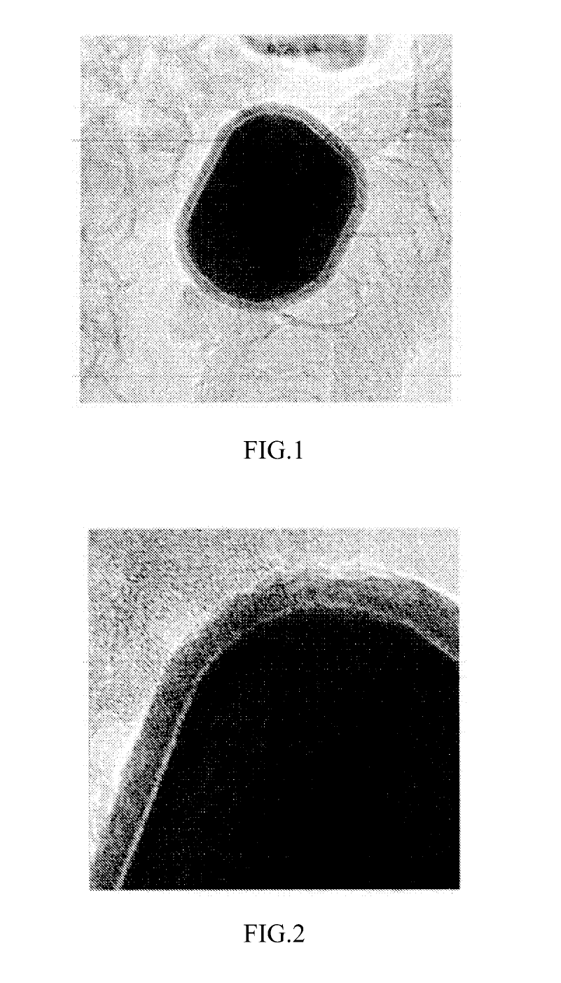

As shown in FIG. 1, the composite positive electrode material obtained by the above method has a core-shell structure, the diameter of the core active material LiMnO₂is 50 nm and the thickness of the shell active material lithium iron phosphate is 5 nm.

### The Second Embodiment

(a) Preparing a core active material which includes: dissolving 1055 g sucrose into 1000 g water; adding 37 g lithium carbonate (Li₂CO₃, 0.5 mol) and 490.2 g manganese acetate (Mn(CH₃COO)₂.4H₂O, 2 mol) into the solution; heating the solution in nitrogen and at a temperature of 150° C. for one and a half hours to get gels; sintering the gels in nitrogen atmosphere at a temperature of 700° C., and keeping the sintering temperature constant for 10 hours to get a core active material lithium manganate LiMn₂O₄.

(b) Preparing a composite positive material with a core-shell structure for a lithium-ion battery which includes: dissolving 388 g sucrose into 1000 g water; adding 3.7 g lithium carbonate (Li₂CO₃, 0.05 mol) and 14.4 g ferrous oxalate (FeC₂O₄.2H₂O, 0.08 mol), 7.5 g aluminium nitrate (Al(NO₃)₃.9H₂O, 0.02 mol), 13.2 g diammonium hydrogen phosphate ((NH₄)₂ HPO₄, 0.1 mol) into the solution; mixing 1.5 g superfine conductive carbon black and 15 g polyethylene glycol and then ultrasonic dispersing into water; mixing two above-mentioned solutions together and adding the core active material lithium manganate LiMn₂O₄ obtained by implementing step (a) to form a mixed solution; heating the mixed solution at a temperature of 100° C. for two hours to get gels; sintering the gels in nitrogen atmosphere at a temperature of 800° C., and keeping the sintering temperature constant for 6 hours to get a composite positive electrode material with a core-shell structure for lithium-ion batteries.

As shown in FIG. 2, the composite positive electrode material obtained by the above method has a core-shell structure.

### The Third Embodiment

(a) Preparing a core active material which includes: dissolving 1314 g edetic acid into 1000 g water; adding 459 g lithium oxalate (Li₂C₂O₄, 4.5 mol) and 1159 g ferrous carbonate (FeCO₃, 10 mol), 30.8 g cadmium nitrate (Cd(NO₃)₂.4H₂O, 1 mol) and 980 g phosphoric acid (H₃PO₄, 10 mol) into the solution; putting the solution in nitrogen and heating the solution at a temperature of 200° C. for one hour to get gels; sintering the gels in nitrogen atmosphere at a temperature of 900° C., and keeping the sintering temperature constant for 3 hours to get a core active material Li_{0.9}Cd_{0.1}FePO₄.

(b) Preparing a composite positive material with a core-shell structure for a lithium-ion battery which includes: dissolving 244 g edetic acid into 1000 g water; adding 4.8 g lithium hydroxide (LiOH, 0.2 mol), 19.2 g iron hydroxide (Fe(OH)₃, 0.18 mol), 5.1 g magnesium nitrate (Mg(NO₃)₂.6H₂O, 0.02 mol) and 19.6 g phosphoric acid (H₃PO₄, 0.2 mol) into the solution; mixing 1 g carbon nanotube and 5 g polyoxyethylene and then ultrasonic dispersing into water; mixing two above-mentioned solutions together and adding the core active material lithium manganate Li_{0.9}Cd_{0.1}FePO₄ obtained by implementing step (a) to form a mixed solution; heating the mixed solution at a temperature of 200° C. for one hour to get gels; sintering the gels in nitrogen atmosphere at a temperature of 700° C., and keeping the sintering temperature constant for 10 hours to get a composite positive electrode material with a core-shell structure for lithium-ion batteries.

The composite positive material prepared by this method has a core-shell structure which was shown in the high resolution transmission electron micrograph.

What is claimed is:

1. A composite positive electrode material with a core-shell structure for a lithium-ion battery, the composite positive electrode material has a core-shell structure which is consists of a core active material and a shell active material, wherein the core active material is a lithium iron phosphate or a lithium manganate, the shell active material is a composite lithium iron phosphate with carbon, the carbon is one or more of carbon nanotube, superfine conductive carbon black and amorphous carbon material, and the composite positive electrode material includes from 65% to 99% core active material and from 1% to 35% shell active material, based on the total weight of the composite positive electrode material.

2. The composite positive electrode material according to claim 1, wherein the shell active material includes from 1% to 10% carbon, based on the total weight of the shell active material.

3. The composite positive electrode material according to claim 1, wherein the lithium iron phosphate is Li_{1-X}M_{X}FePO₄ or LiFe_{1-y}M_{y}PO₄, the doped element M of which is selected from one or more of boron, cadmium, copper, magnesium, aluminum, zinc, titanium, zirconium, niobium, chromium and rare-earth element, the value ranges of variable x is 0<x<1 and the value ranges of variable y is 0<y<1.

4. The composite positive electrode material according to claim 3, wherein the doped element M is selected from at least one of boron and cadmium.

5. The composite positive electrode material according to claim 1, wherein the lithium manganate is LiMnO₂ which has a stratiform structure or LiMn₂O₄ which has a spinel structure.

6. A preparing method of the composite positive electrode material with a core-shell structure for a lithium-ion battery according to claim 1, the preparing method comprising the following steps:
(a) preparing a core active material which comprises: dissolving stoichiometric lithium source, iron source, phosphorus source, doped element source or stoichiometric lithium source, manganese source into an aqueous solution which contains complexing agent, putting the solution in nitrogen and heating the solution at a temperature of 100˜200° C. for 1˜2 hours to get gels, sintering the gels in inert or reducing atmosphere at a temperature of 500˜900° C., and keeping the sintering temperature constant for 3˜16 hours to get a core active material; and
(b) preparing a composite positive material which comprises: dissolving stoichiometric lithium source, iron source, phosphorus source, doped element source into an aqueous solution which contains complexing agent, mixing a carbon and an accessory ingredient and then ultrasonic dispersing into an aqueous solution, mixing the two kinds of solutions and adding the core active material to form a mixed solution, heating the mixed solution at a temperature of 100˜200° C. for 1˜2 hours to get gels, sintering the gels in inert or reducing atmosphere at a temperature of 500˜900° C., and keeping the sintering temperature constant for 3˜16 hours to get a composite positive electrode material with a core-shell structure for lithium-ion batteries.

7. The preparing method according to claim 6, wherein, in the step (a), the weight of complexing agent is 0.1˜10 times of the total weight of lithium source, iron source, phosphorus source and doped element source or the total weight of lithium source and manganese source.

8. The preparing method according to claim 6, wherein, in the step (b), the weight ratio of carbon and accessory ingredient is 1:0.01˜10; the weight of complexing agent is 0.1˜10 times of the total weight of lithium source, iron source, phosphorus source and doped element source.

9. The preparing method according to claim 6, wherein the lithium source is one or more of lithium oxide, lithium hydroxide, lithium acetate, lithium carbonate, lithium nitrate, lithium nitrite, lithium phosphate, lithium dihydrogen phosphate, lithium oxalate, lithium chloride, lithium molybdate, lithium vanadate; the iron source is one or more of ferric phosphate, ferrous phosphate, ferrous pyrophosphate, ferrous carbonate, ferrous chloride, ferrous hydroxide, ferrous nitrate, ferrous oxalate, ferric chloride, ferric hydroxide, ferric nitrate, ferric citrate, ferric sesquioxide; the phosphorus source is one or more of phosphoric acid, diammonium phosphate, ammonium dihydrogen phosphate, ferric phosphate, lithium dihydrogen phosphate; the manganese source is one or more of manganese nitrate, manganese acetate, manganese chloride; the doped element source is a soluble-salt of doped element M; the complexing agent is one or more of citric acid, malic acid, tartaric acid, oxalic acid, salicylic acid, succinic acid, glycocoll, edetic acid, sucrose, glucose; the accessory ingredient is one or more of polyving akohol, polyethylene glycol, polyoxyethylene, sodium polystyrene sulfonate, triton S-100, polyoxyethylene nonyl phenyl ether, hexadecyl trimethyl ammonium chloride, hexadecyl trimethyl ammonium bromide, octadecyl trimethyl ammonium chloride, octadecyl trimethyl ammonium bromide.

10. The preparing method according to claim 6, wherein the inert or reductive atmosphere is one or more of hydrogen, nitrogen, argon, paraffin, alkene, alcohol and ketone.
